(19) United States
(12) Patent Application Publication
(10) Pub. No.: US 2026/0318517 A1
(43) Pub. Date: Oct. 15, 2026

(54) INDUSTRIAL LIGHT FIXTURE

(71) Applicant: Xiamen PVTECH Co., Ltd., Xiamen (CN)

(72) Inventors: WEIMING GUO, Xiamen (CN); FUXING LU, Xiamen (CN); ZONGHUI ZHAN, Xiamen (CN); YANLING XIAO, Xiamen (CN); HAO LUO, Xiamen (CN); PENGYU CHEN, Xiamen (CN)

(21) Appl. No.: 19/422,495

(22) Filed: Dec. 17, 2025

(30) Foreign Application Priority Data
Dec. 31, 2024 (CN) 202411988628.7
Dec. 31, 2024 (CN) 202411989970.9
Dec. 31, 2024 (CN) 202411990001.5

(51) Int. Cl. F21V 21/30

(52) U.S. Cl. CPC F21V 21/30

(57) ABSTRACT

An industrial light fixture includes a base and a plurality of light source modules. The base has a first pivot portion and a second pivot portion, and the base includes a first serrated structure disposed at the first pivot portion. The light source modules are respectively pivotally connected to the two sides of the base. Each of the light source modules includes an optical lens, a light source board, and a housing. The optical lens and the light source board are disposed in the housing. Each of the light source modules has a first shaft portion pivotally connected to the first pivot portion and a second shaft portion pivotally connected to the second pivot portion. The first shaft portion has a second serrated structure engaged with the first serrated structure.

### TECHNICAL FIELD

The disclosure relates to a lighting device, in particular to an industrial light fixture.

### BACKGROUND

Lighting devices have become an indispensable tool in daily life, which are applicable to various industries and fields, such as household lighting, commercial lighting, industrial lighting, and transportation lighting. LED industrial light fixtures are generally used in large public factories, manufacturing bases or public facilities, such as workshops, plants, gas stations, and shopping malls, including supermarkets, museums, and stadiums.

At present, mainstream industrial light fixtures on the market are limited by the sheet-metal fabrication process, resulting in similar appearances, and their heat dissipation performance is poor. Besides, the light-emitting angle of the light source modules thereof is not adjustable, which restricts the application range. In addition, the currently available products cannot fully meet the actual requirements in terms of functionality.

Moreover, the current installation method of industrial light fixtures on the market mainly relies on chain suspension, but this structure cannot meet the requirements of different applications.

### SUMMARY

One embodiment of the disclosure provides an industrial light fixture includes a base and a plurality of light source modules. The base has a first pivot portion and a second pivot portion, and the base includes a first serrated structure disposed at the first pivot portion. The light source modules are respectively pivotally connected to the two sides of the base. Each of the light source modules includes an optical lens, a light source board, and a housing. The optical lens and the light source board are disposed in the housing. Each of the light source modules has a first shaft portion pivotally connected to the first pivot portion and a second shaft portion pivotally connected to the second pivot portion. The first shaft portion has a second serrated structure engaged with the first serrated structure.

In summary, the light source modules on the two sides of the industrial light fixture can be manually rotated and folded to adjust the light-emitting angle of the industrial light fixture. With an excellent optical design, the illuminance of the industrial light fixture is more than 30% higher than that of currently available products under the same power. The light source module, as an integrated unit, is replaceable. In addition, the industrial light fixture features a novel appearance and a simple structure, which can meet market demands.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The disclosure will become more fully understood from the detailed description given herein below and the accompanying drawings which are given by way of illustration only, and thus are not limitative of the disclosure and wherein:

FIG. 1 is a first perspective view of an industrial light fixture in accordance with a first embodiment of the disclosure.

FIG. 2 is a second perspective view of the industrial light fixture in accordance with the first embodiment of the disclosure.

FIG. 3 is an exploded view of the industrial light fixture in accordance with the first embodiment of the disclosure.

FIG. 4 is a sectional view of the industrial light fixture in accordance with the first embodiment of the disclosure.

FIG. 5 is an enlarged view of a A part and a B part of the industrial light fixture in accordance with the first embodiment of the disclosure.

FIG. 6 is a partial enlarged view of the industrial light fixture in accordance with the first embodiment of the disclosure.

FIG. 7 is a partial enlarged view of a housing of a light source module of the industrial light fixture in accordance with the first embodiment of the disclosure.

FIG. 8 is a schematic view of an unfolded state of the light source modules of the industrial light fixture in accordance with the first embodiment of the disclosure.

FIG. 9 is a schematic view of a first folded state of the light source modules of the industrial light fixture in accordance with the first embodiment of the disclosure.

FIG. 10 is a schematic view of a second folded state of the light source modules of the industrial light fixture in accordance with the first embodiment of the disclosure.

FIG. 11 is a perspective view of an industrial light fixture in accordance with a second embodiment of the disclosure.

FIG. 12 is a first perspective view of a light source module of the industrial light fixture in accordance with the second embodiment of the disclosure.

FIG. 13 is a second perspective view of the light source module of the industrial light fixture in accordance with the second embodiment of the disclosure.

FIG. 14 is a sectional view of the light source module of the industrial light fixture in accordance with the second embodiment of the disclosure.

FIG. 15 is an exploded view of the light source module of the industrial light fixture in accordance with the second embodiment of the disclosure.

FIG. 16 is a perspective view of a side cover assembly of the industrial light fixture in accordance with the second embodiment of the disclosure.

FIG. 17 is a top view of the side cover assembly of the industrial light fixture in accordance with the second embodiment of the disclosure.

FIG. 18 is a first partial enlarged view of the light source module of the industrial light fixture in accordance with the second embodiment of the disclosure (the side cover assembly is opened).

FIG. 19 is a perspective view of the light source module of the industrial light fixture in accordance with the second embodiment of the disclosure (the side cover assembly is opened).

FIG. 20 is a top view of the light source module of the industrial light fixture in accordance with the second embodiment of the disclosure (the side cover assembly is opened).

FIG. 21 is a schematic view of the light source module of the industrial light fixture in accordance with the second embodiment of the disclosure (the process of replacing the optical lens).

FIG. 22 is a second partial enlarged view of the light source module of the industrial light fixture in accordance with the second embodiment of the disclosure.

FIG. 23 is a partial enlarged view of a first shaft portion and a second shaft portion of the light source module of the industrial light fixture in accordance with the second embodiment of the disclosure.

FIG. 24 is a perspective view of an industrial light fixture in accordance with a third embodiment of the disclosure.

FIG. 25 is an exploded view of the industrial light fixture in accordance with the third embodiment of the disclosure.

FIG. 26 is an exploded view of a ceiling box of the industrial light fixture in accordance with the third embodiment of the disclosure.

FIG. 27 is a view showing the ceiling box of FIG. 24 from different view angles.

FIG. 28 is a first schematic view of the industrial light fixture in accordance with the third embodiment of the disclosure (before assembly).

FIG. 29 is a second schematic view of the industrial light fixture in accordance with the third embodiment of the disclosure (during assembly).

FIG. 30 is a third schematic view of the industrial light fixture in accordance with the third embodiment of the disclosure (after assembly).

FIG. 31 is a first side view of the industrial light fixture in accordance with the third embodiment of the disclosure (before assembly).

FIG. 32 is a second side view of the industrial light fixture in accordance with the third embodiment of the disclosure (after assembly).

FIG. 33 is a first partial enlarged view of the industrial light fixture in accordance with the third embodiment of the disclosure (after assembly).

FIG. 34 is a second partial enlarged view of the industrial light fixture in accordance with the third embodiment of the disclosure (before assembly).

FIG. 35 is a partial enlarged view of the ceiling box of the industrial light fixture in accordance with the third embodiment of the disclosure.

FIG. 36 is a perspective view of an industrial light fixture in accordance with a fourth embodiment of the disclosure.

FIG. 37 is a perspective view of an industrial light fixture in accordance with a fifth embodiment of the disclosure.

FIG. 38 is an exploded view of a light source module of an industrial light fixture in accordance with the fifth embodiment of the disclosure.

FIG. 39 is a perspective view of an industrial light fixture in accordance with a sixth embodiment of the disclosure.

FIG. 40 is a first perspective view of a splicing member of an industrial light fixture in accordance with a seventh embodiment of the disclosure.

FIG. 41 is a second perspective view of the splicing member of the industrial light fixture in accordance with the seventh embodiment of the disclosure.

FIG. 42 is a first partial enlarged view of the industrial light fixture in accordance with the seventh embodiment of the disclosure.

FIG. 43 is a second partial enlarged view of the industrial light fixture in accordance with the seventh embodiment of the disclosure.

FIG. 44A is a third partial enlarged view of the industrial light fixture in accordance with the seventh embodiment of the disclosure. FIG. 44B is a fourth partial enlarged view of the industrial light fixture in accordance with the seventh embodiment of the disclosure.

FIG. 45 is a perspective view of a lighting module in accordance with the seventh embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

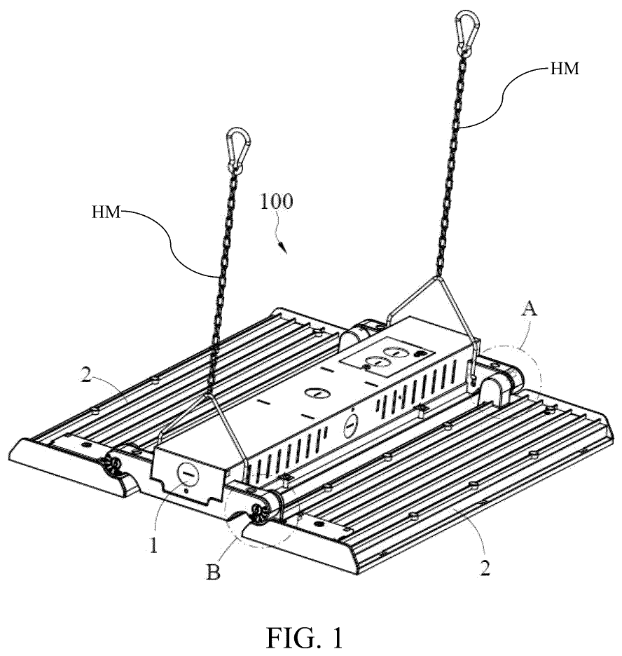

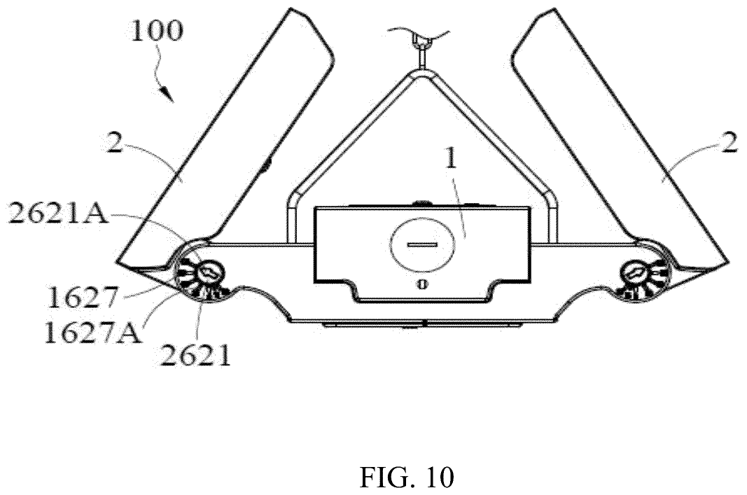

Please refer to FIG. 1. FIG. 1 is a first perspective view of an industrial light fixture in accordance with a first embodiment of the disclosure. A light source module 2 includes a left module and a right module, and both the left and right modules can be manually rotated and folded within an angular range defined by a horizontal line, from 30 degrees downward to 120 degrees upward (as shown in FIG. 9 and FIG. 10). By adjusting the angles of the above modules, the range of the light-emitting angle of the industrial light fixture 100 can be changed.

Please refer to FIG. 1. The industrial light fixture 100 includes a base 1 (a power supply module is disposed inside the base 1) and a plurality of light source modules 2. Each light source module 2 is pivotally connected to the two sides of the base 1, such that each light source module 2 can rotate and fold relative to the base 1 for angle adjustment.

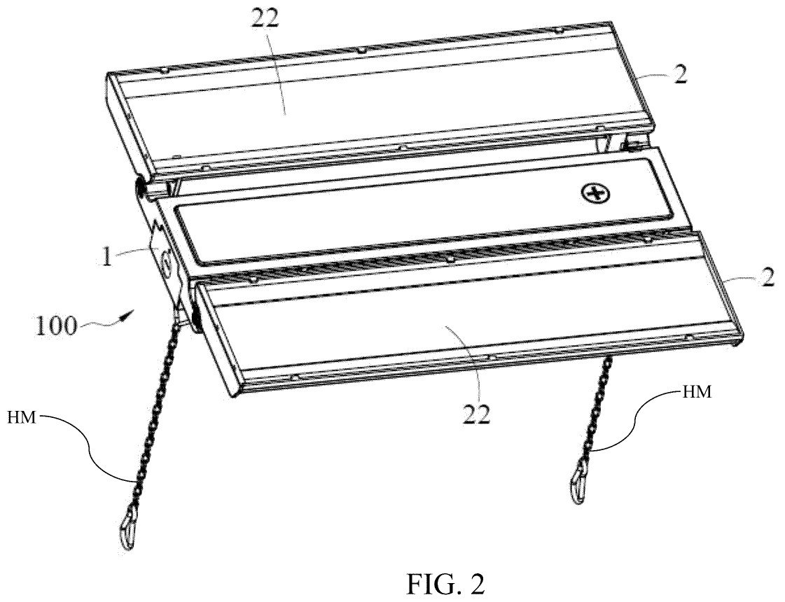

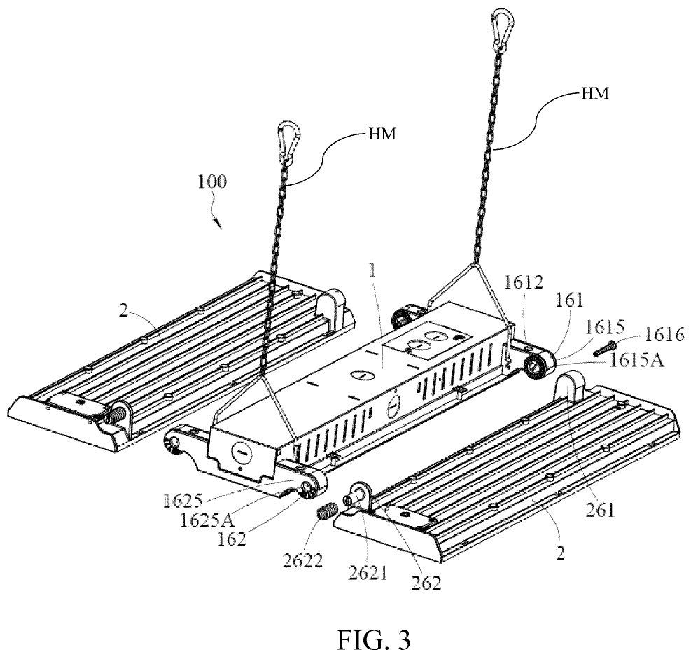

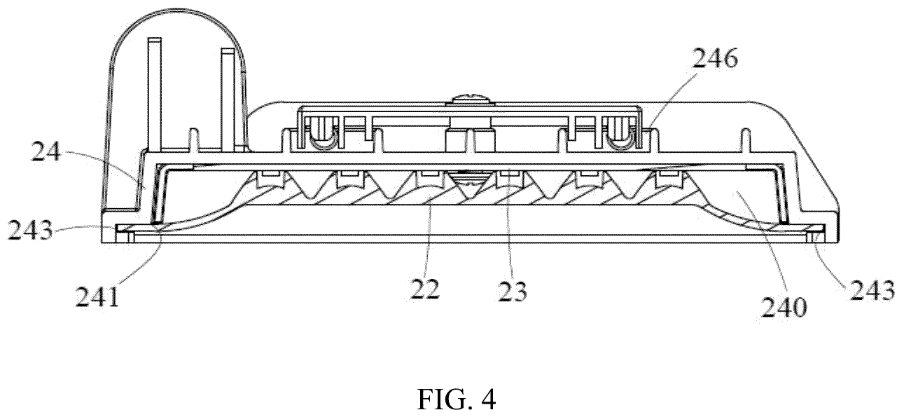

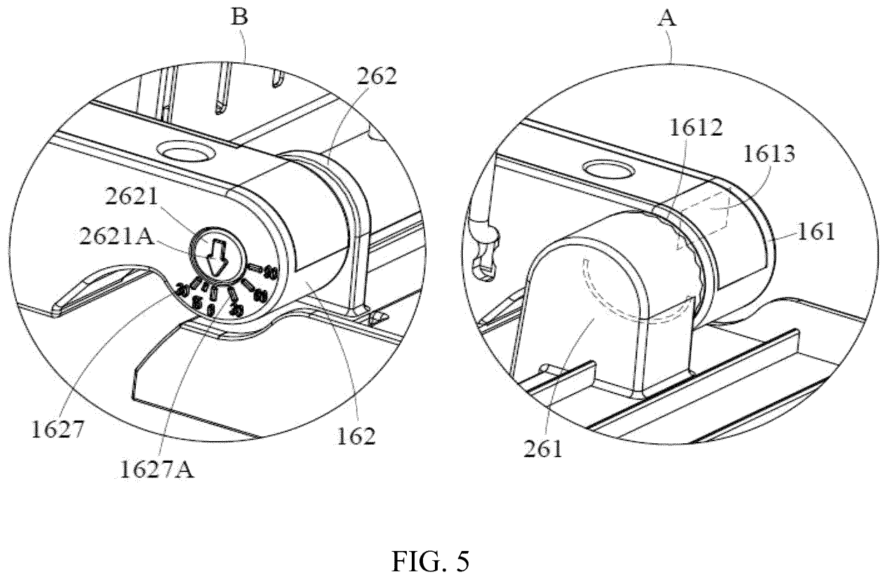

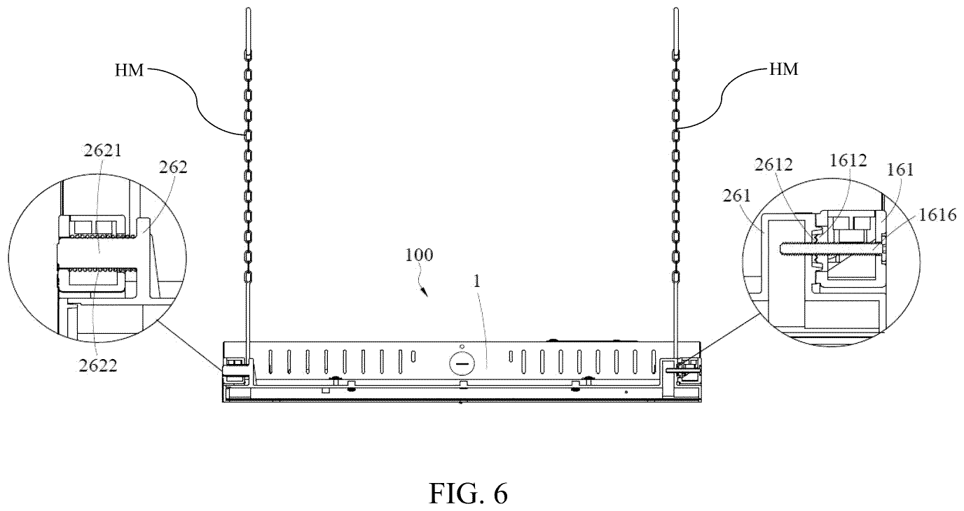

Please refer to FIG. 1 to FIG. 6. FIG. 2 is a second perspective view of the industrial light fixture in accordance with the first embodiment of the disclosure. FIG. 3 is an exploded view of the industrial light fixture in accordance with the first embodiment of the disclosure. FIG. 4 is a sectional view of the industrial light fixture in accordance with the first embodiment of the disclosure. FIG. 5 is an enlarged view of a A part and a B part of the industrial light fixture in accordance with the first embodiment of the disclosure. FIG. 6 is a partial enlarged view of the industrial light fixture in accordance with the first embodiment of the disclosure. The base 1 includes a first pivot portion 161 and a second pivot portion 162, which are respectively connected to a first shaft portion 261 and a second shaft portion 262 of each light source module 2. The first pivot portion 161 and the second pivot portion 162 are both lateral cantilever structures. The inner surface of the first pivot portion 161 is provided with an annularly arranged first serrated structure 1612 for gear engagement. The first pivot portion 161 is provided with a first coupling shaft 1615 having a first circular hole 1615A. A bolt member 1616 can pass through the first circular hole 1615A to screw the first shaft portion 261 of the light source module 2 and the first coupling shaft 1615 together. The first pivot portion 161 is provided with a stopper 1613 to limit the rotation range of the light source module 2. The second pivot portion 162 is provided with a second coupling shaft 1625 having a second circular hole 1625A. An outer surface of the second coupling shaft 1625 is provided with a scale portion 1627 having a plurality of scale lines 1627A. The angle between any two of the scale lines 1627A adjacent thereto is consistent (for example, 13 degrees, 15 degrees, or 17 degrees). The scale lines 1627A are annularly arranged around the second circular hole 1625A, centered thereon. In some embodiments, the entire range of the scale lines 1627A extends from −30 degrees to 120 degrees, with angular markings at intervals of 15 degrees. In addition, the industrial light fixture 100 may further include two hanging members HM, such as chains, ropes, or other similar components, which can be respectively disposed at the two ends of the base 1. In this manner, the industrial light fixture 100 can be suspended from a ceiling or other suitable locations.

Please refer to FIG. 1 to FIG. 6. In some embodiments, the structure of the light source module 2 is designed to facilitate angular adjustment and provide optical illumination. The light source module 2 includes an optical lens 22, a light source board 23, and a housing 24. The housing 24 has an elongated flat box shape, with a generally trapezoidal cross section. The optical lens 22 and the light source board 23 are disposed on the housing 24. The light source module 2 has a first shaft portion 261 and a second shaft portion 262 respectively disposed at the two ends of the housing 24. The first shaft portion 261 is an upright shaft column structure extending from the housing 24, while the second shaft portion 262 is an upright coupling shaft structure. The first shaft portion 261 is pivotally connected to the first pivot portion 161, and the second shaft portion 262 is pivotally connected to the second pivot portion 162. The first shaft portion 261 further includes a second serrated structure 2612, which engages with the first serrated structure 1612 to form a stable connection.

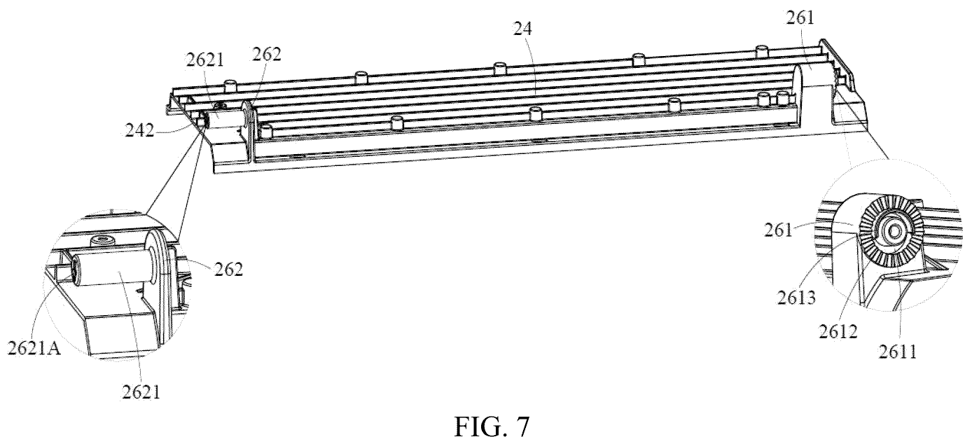

Please refer to FIG. 1 to FIG. 7. FIG. 7 is a partial enlarged view of a housing of a light source module of the industrial light fixture in accordance with the first embodiment of the disclosure. In some embodiments, the housing 24 includes an internal space 240, an opening region 241, and a side port region 242. The light source board 23 is disposed inside the housing 24. The side port region 242 is provided with a first guide groove 243 for limiting and fixing the two sides of the optical lens 22. The optical lens 22 is inserted into the first guide groove 243 from both sides, and during sliding, it is constrained by the groove and an upper protrusion. The housing 24 is provided with heat-dissipation fins to enhance thermal performance, and a second guide groove 246 is formed at the fins region. The light source board 23 is installed in the internal space 240 and serves as the light-emitting element. The optical lens 22 covers the opening region 241 to modify the light-emitting angle of the light source board 23. The detachable design allows convenient replacement.

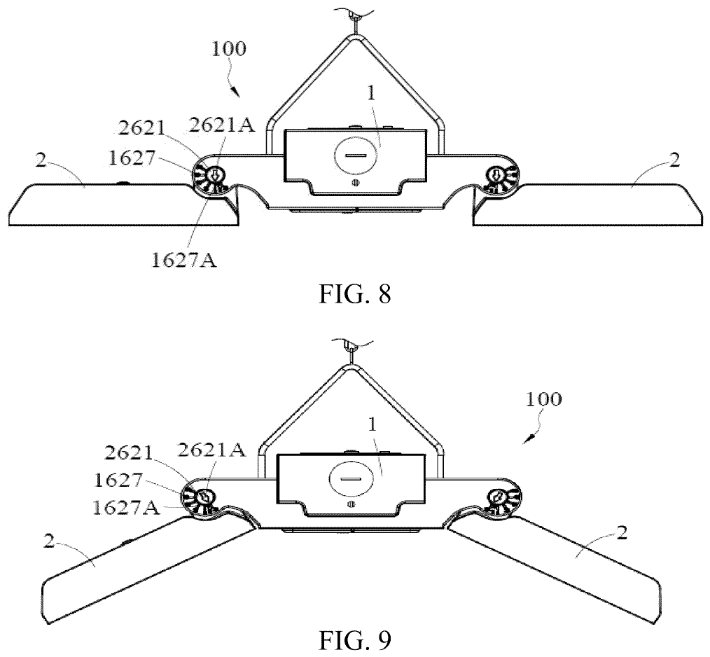

Please refer to FIG. 3 to FIG. 8. FIG. 8 is a schematic view of an unfolded state of the light source modules of the industrial light fixture in accordance with the first embodiment of the disclosure. In some embodiments, the first shaft portion 261 of the light source module 2 is provided with a wire outlet hole 2611 for routing electrical wires between the power supply and the light source, thus concealing the wiring and achieving a neat appearance. The first serrated structure 1612 of the first pivot portion 161 engages with the second serrated structure 2612 of the first shaft portion 261 to form a stable connection. Furthermore, the first shaft portion 261 has a protrusion portion 2613 (as shown in FIG. 7), which rotatably presses against the stopper 1613 of the first pivot portion 161 to limit the rotation range. Additionally, the second shaft portion 262 includes a protruding shaft portion 2621 inserted into the second circular hole 1625A of the second pivot portion 162. The outer surface of the protruding shaft portion 2621 is exposed outside the second circular hole 1625A and provided with an indicating arrow 2621A to point to the scale lines 1627A. A spring 2622 is disposed between the second shaft portion 262 and the second coupling shaft 1625 to provide elastic support and damping.

Please refer to FIG. 3 to FIG. 8. In some embodiments, the assembly method between the base 1 and the light source module 2 is as follows: the first shaft portion 261 of the light source module 2 is pivotally connected to the first pivot portion 161 of the base 1, and the bolt member 1616 passes through the first circular hole 1615A to secure the connection. The second serrated structure 2612 of the first shaft portion 261 engages with the first serrated structure 1612 to provide stable rotation control. Meanwhile, the protrusion portion 2613 of the first shaft portion 261 contacts the stopper 1613 to limit the rotation range. In addition, the second shaft portion 262 of the light source module 2 is aligned with the second pivot portion 162 of the base 1, such that the protruding shaft portion 2621 is inserted and pivotally connected into the second circular hole 1625A, with the spring 2622 providing elastic support. The indicating arrow 2621A on the protruding shaft portion 2621 corresponds to the scale lines 1627A on the scale portion 1627 to indicate the rotation angle.

Please refer to FIG. 3 to FIG. 10. FIG. 9 is a schematic view of a first folded state of the light source modules of the industrial light fixture in accordance with the first embodiment of the disclosure. FIG. 10 is a schematic view of a second folded state of the light source modules of the industrial light fixture in accordance with the first embodiment of the disclosure. In some embodiments, when the user manually rotates the light source module 2, the second serrated structure 2612 of the first shaft portion 261 slides and engages with the first serrated structure 1612 of the first pivot portion 161, producing a gear-like adjustment sensation. Simultaneously, the protruding shaft portion 2621 of the second shaft portion 262 rotates within the second circular hole 1625A, while the spring 2622 provides elastic compression to ensure tight gear engagement and controlled damping stability. When rotated to a specific angle, the indicating arrow 2621A of the protruding shaft portion 2621 aligns with a corresponding scale line 1627A, indicating the current angular position of the light source module 2.

Please refer to FIG. 8 to FIG. 10. When the indicating arrow 2621A points to 0 degrees, the two light source modules 2 are aligned horizontally on the two sides of the base 1, suitable for wide-area uniform illumination. When the indicating arrow 2621A points to −30 degrees, the two light source modules 2 are folded downward so that the optical lenses 22 face each other, suitable for downward localized lighting. When the indicating arrow 2621A points to 120 degrees, the two light source modules 2 are folded upward so that the optical lenses 22 face in opposite directions, suitable for spotlighting. The engagement between serrated structures enables angular adjustment, with each scale interval corresponding to a physical rotation of 15 degrees. This adjustable-angle design allows the industrial light fixture 100 to accommodate diverse industrial lighting applications, achieving wide, efficient, and directional illumination. The foldable module design reduces transportation and storage costs, improving packaging efficiency and appearance.

To sum up, the light source modules 2 on the two sides of the industrial light fixture 100 can be manually rotated and folded to physically adjust the lighting angle of the industrial light fixture 100. The excellent optical design provides more than 30% higher illuminance compared to currently available products of the same power. Each light source module 2 is designed as an integrated replaceable unit. Furthermore, the industrial light fixture 100 features a novel appearance and simple structure that meets market demands.

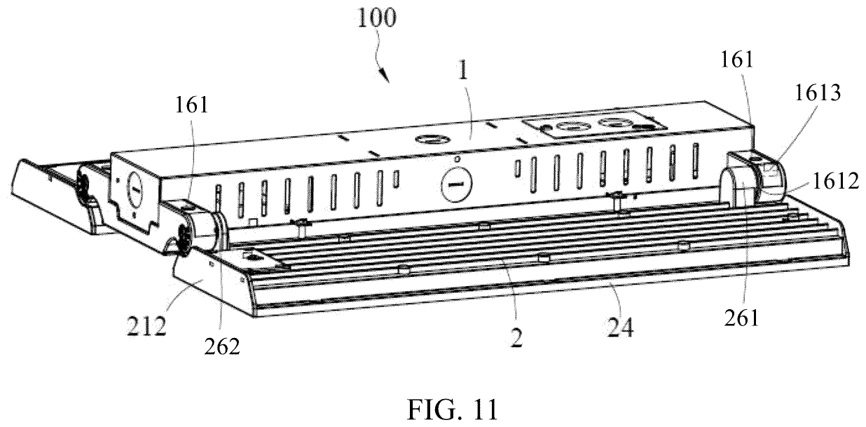

Please refer to FIG. 11. FIG. 11 is a perspective view of an industrial light fixture in accordance with a second embodiment of the disclosure. The light source module 2 and the base 1 are combined as a set, and the light source module 2 is divided into a left module and a right module. The left and right modules can be manually rotated and folded, with an angular range based on the horizontal line, downward to 30 degrees and upward to 120 degrees. By adjusting the angles of the above modules, the range of the light-emitting angle of the industrial light fixture 100 can be changed.

Please refer to FIG. 11. The industrial light fixture 100 includes the base 1 and a plurality of light source modules 2, featuring a high-efficiency optical and modular structure.

Please refer to FIG. 11. The base 1 serves as a supporting structure and includes a first pivot portion 161. The first pivot portion 161 is provided with a first serrated structure 1612 and a stopper 1613 for pivotally connecting and mounting the light source module 2.

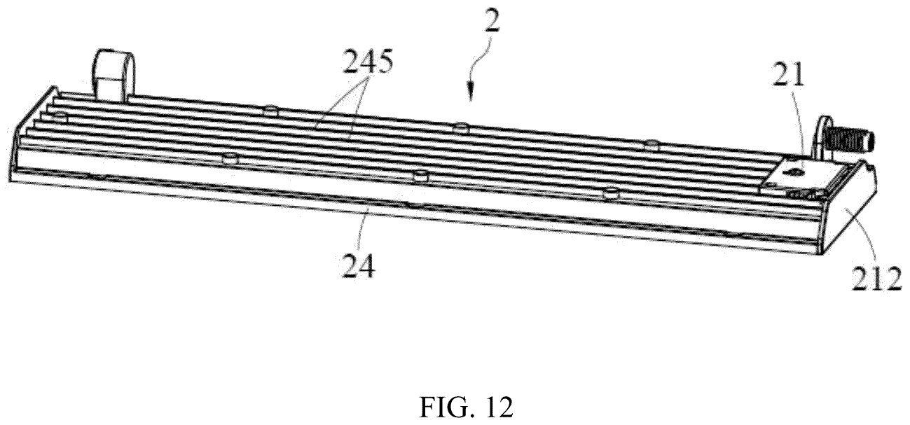

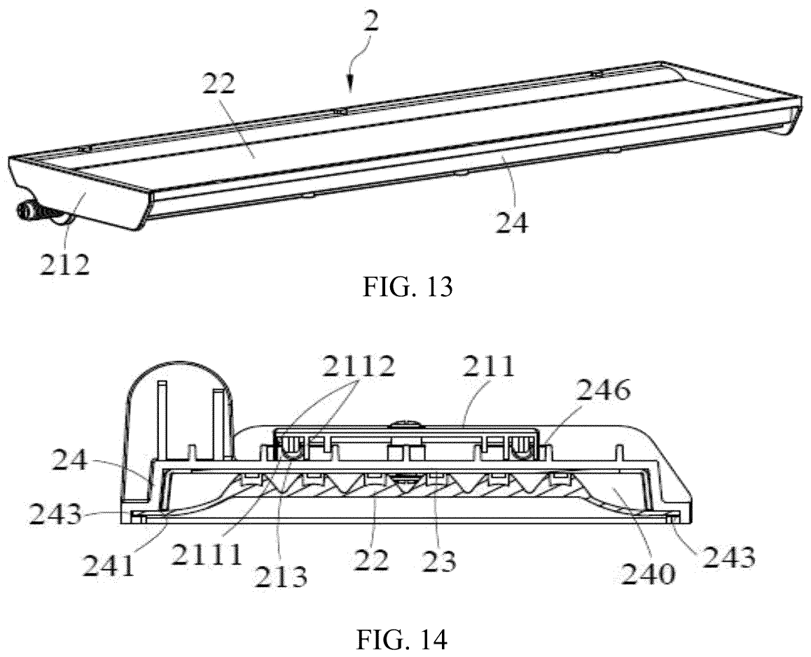

Please refer to FIGS. 11 to 13. FIG. 12 is a first perspective view of a light source module of the industrial light fixture in accordance with the second embodiment of the disclosure. FIG. 13 is a second perspective view of the light source module of the industrial light fixture in accordance with the second embodiment of the disclosure. The light source module 2 includes a housing 24, a side cover assembly 21, an optical lens 22, and a light source board 23 disposed on the housing 24. The housing 24 is a long flat box structure having a generally trapezoidal cross-section.

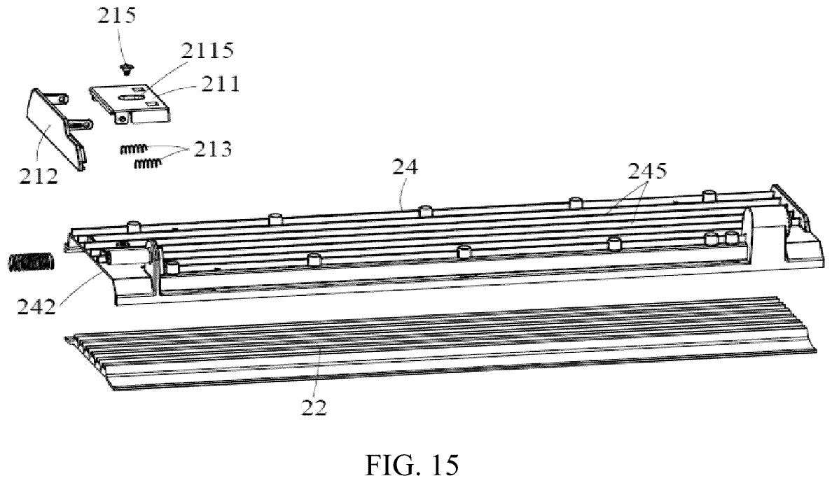

Please refer to FIGS. 14 to 15. FIG. 14 is a sectional view of the light source module of the industrial light fixture in accordance with the second embodiment of the disclosure. FIG. 15 is an exploded view of the light source module of the industrial light fixture in accordance with the second embodiment of the disclosure. The housing 24 includes an internal space 240, an opening region 241, and a side port region 242. The light source board 23 is housed inside the housing 24. The side port region 242 is provided with a first guide groove 243 for positioning and limiting the two sides of the optical lens 22. The housing 24 further includes heat-dissipating fins 245, which contain a second guide groove 246 to improve heat dissipation performance. The light source board 23 is installed in the internal space 240 and is responsible for light emission. The optical lens 22 covers the opening region 241 and serves to change the light-emitting angle of the light source board 23. The detachable design allows convenient replacement.

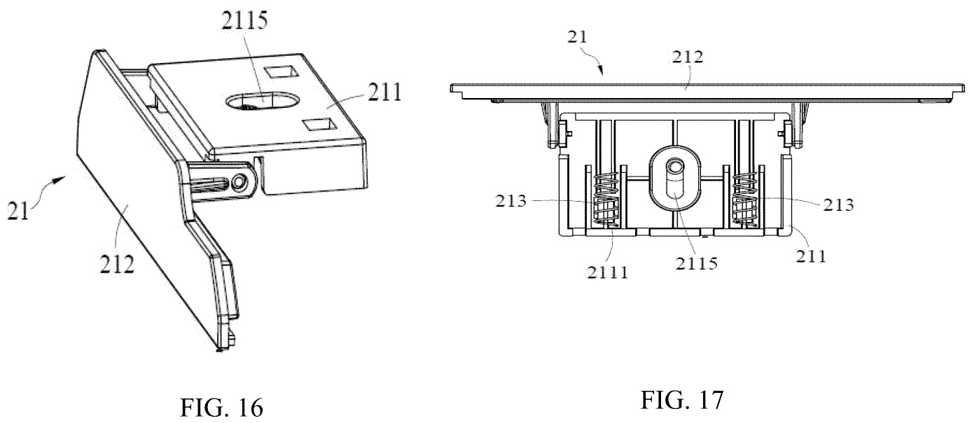

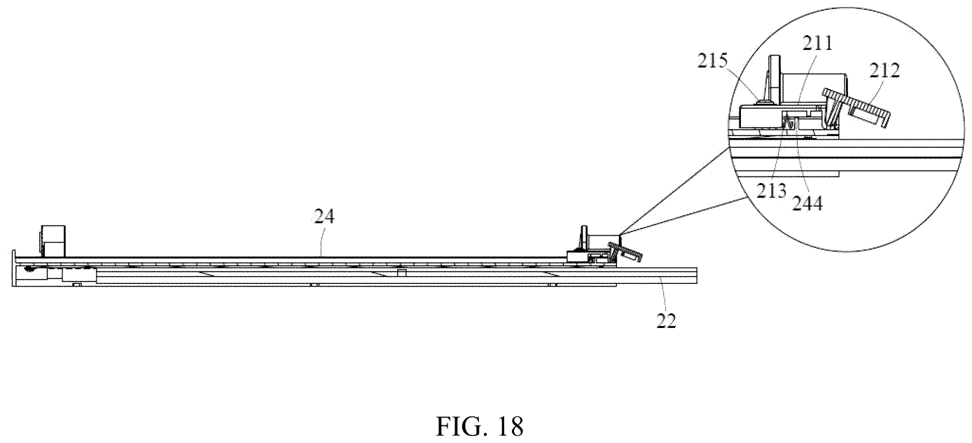

Please refer to FIGS. 15 to 17. FIG. 16 is a perspective view of a side cover assembly of the industrial light fixture in accordance with the second embodiment of the disclosure. FIG. 17 is a top view of the side cover assembly of the industrial light fixture in accordance with the second embodiment of the disclosure. The side cover assembly 21 includes a first side cover plate 211, a second side cover plate 212, and a plurality of elastic members 213. The first side cover plate 211 has a plurality of tongue pieces 2112, with each elastic member 213 being positioned between two adjacent tongue pieces 2112. The first side cover plate 211 is provided with clamping slots 2111 and tongue pieces 2112 for mounting the elastic members 213. The two ends of each elastic member 213 respectively press against the first side cover plate 211 and the ribs 244 of the housing 24 (as shown in FIG. 18), thereby cooperating with the ribs 244 to elastically position and fix the elastic members 213. The first side cover plate 211 includes two circular holes, each engaging with two circular shafts under the second side cover plate 212. The second side cover plate 212 is coupled to the first side cover plate 211 through the circular shafts 2126, allowing a flipping function. The side cover assembly 21 further includes screw members 215 fixed to the housing 24.

Please refer to FIGS. 15 to 17. In some embodiments, the light source board 23 is installed in the internal space 240 of the housing 24, the optical lens 22 covers the opening region 241, and the side cover assembly 21 is fixed to the side port region 242 of the housing 24.

Please refer to FIGS. 15 to 17. In some embodiments, the two sides of the optical lens 22 are inserted into the first guide grooves 243 and are restricted in movement by the grooves and upper protrusions. The second guide groove 246 on the heat-dissipating fins 245 serves to guide the movement of the side cover assembly 21.

Please refer to FIG. 11 and FIG. 15 to FIG. 17. In some embodiments, the light source module 2 has a first shaft portion 261 and a second shaft portion 262 pivotally connected to the base 1. The first shaft portion 261 and the second shaft portion 262 are respectively disposed on the two sides of the light source module 2. The first shaft portion 261 includes a wire outlet hole 2611 for passing electrical wires to connect the power source and the light source. The wire outlet hole 2611 hides the wiring, ensuring a clean appearance without exposed wires. The first serrated structure 1612 of the base 1 engages with the second serrated structure 2612 to form a stable connection. The first shaft portion 261 includes a protrusion portion 2613 that can rotate to press against the stopper 1613 of the first pivot portion 161.

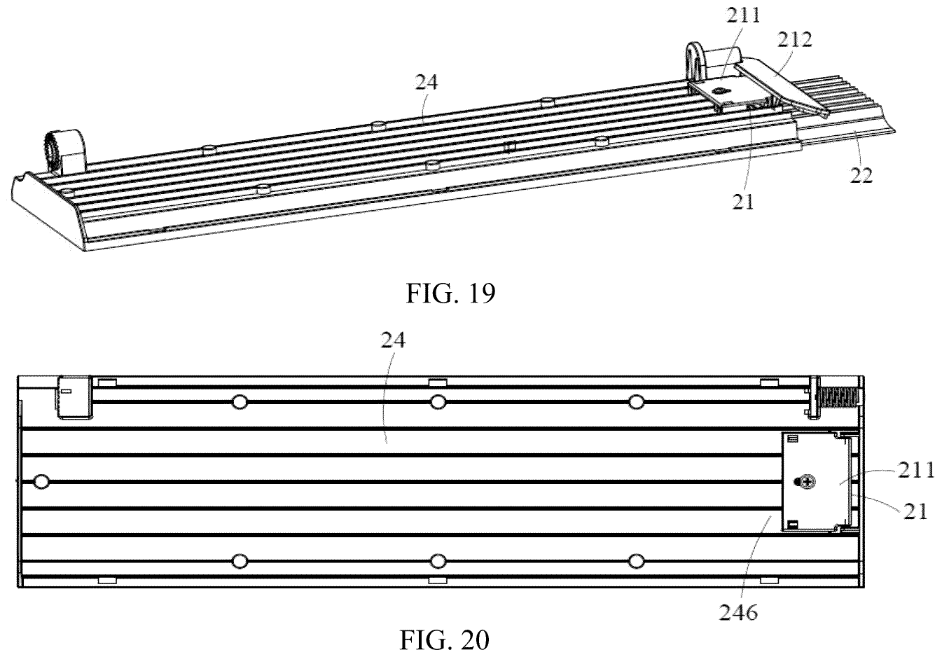

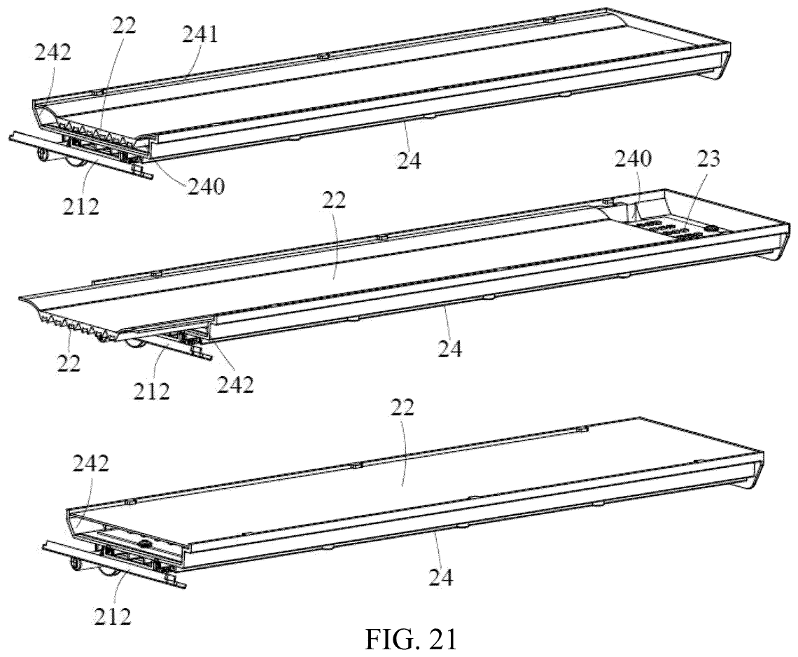

Please refer to FIGS. 15 to 21. FIG. 18 is a first partial enlarged view of the light source module of the industrial light fixture in accordance with the second embodiment of the disclosure (the side cover assembly is opened). FIG. 19 is a perspective view of the light source module of the industrial light fixture in accordance with the second embodiment of the disclosure (the side cover assembly is opened). FIG. 20 is a top view of the light source module of the industrial light fixture in accordance with the second embodiment of the disclosure (the side cover assembly is opened). FIG. 21 is a schematic view of the light source module of the industrial light fixture in accordance with the second embodiment of the disclosure (the process of replacing the optical lens). When a user gently pulls the first side cover plate 211 of the side cover assembly 21, the side cover assembly 21 slides leftward because of being limited by the ribs 244, while the elastic members 213 compress between the tongue pieces 2112. During movement, the first side cover plate 211 can be flipped open, exposing the side end of the optical lens 22. The user can then pull one side of the optical lens 22 to slide it out from the first guide groove 243, allowing easy removal and replacement. By replacing different optical lenses 22, various lighting requirements can be fulfilled, such as aisle lighting or wide-area illumination. The special optical design increases illumination intensity by 30% under the same power, significantly enhancing optical efficiency and application flexibility.

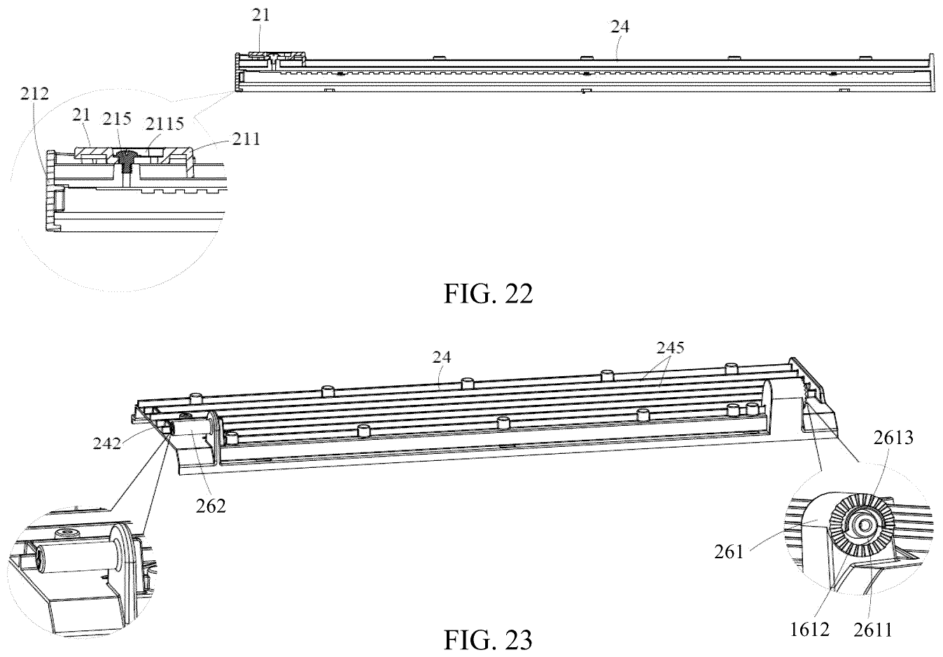

Please refer to FIGS. 15 and 22. FIG. 22 is a second partial enlarged view of the light source module of the industrial light fixture in accordance with the second embodiment of the disclosure. In some embodiments, the first side cover plate 211 is fastened to the housing 24 through the elongated hole 2115 using the screw member 215. One end of each elastic member 213 is mounted in the clamping slot 2111 (as shown in FIG. 7), while the other end presses against the rib 244 (as shown in FIG. 8).

Please refer to FIGS. 11 and 23. FIG. 23 is a partial enlarged view of a first shaft portion and a second shaft portion of the light source module of the industrial light fixture in accordance with the second embodiment of the disclosure. In some embodiments, the first shaft portion 261 and the second shaft portion 262 of the light source module 2 are pivotally connected to the first pivot portion 161 and the second pivot portion 162 of the base 1. The first serrated structure 1612 and the second serrated structure 2612 are engaged with each other to ensure stable angular positioning. The protrusion portion 2613 rotates to contact the stopper 1613, providing additional support.

To sum up, the optical lens 22 of the industrial light fixture 100 is replaceable, allowing different light distributions according to various industrial scenarios, including aisle-specific lighting. The superior optical design increases illumination by more than 30% compared to currently available products under the same power. The light source module 2, designed as an integrated unit, is replaceable. Furthermore, the industrial light fixture 100 features a novel appearance and a simple structure that meets market demands.

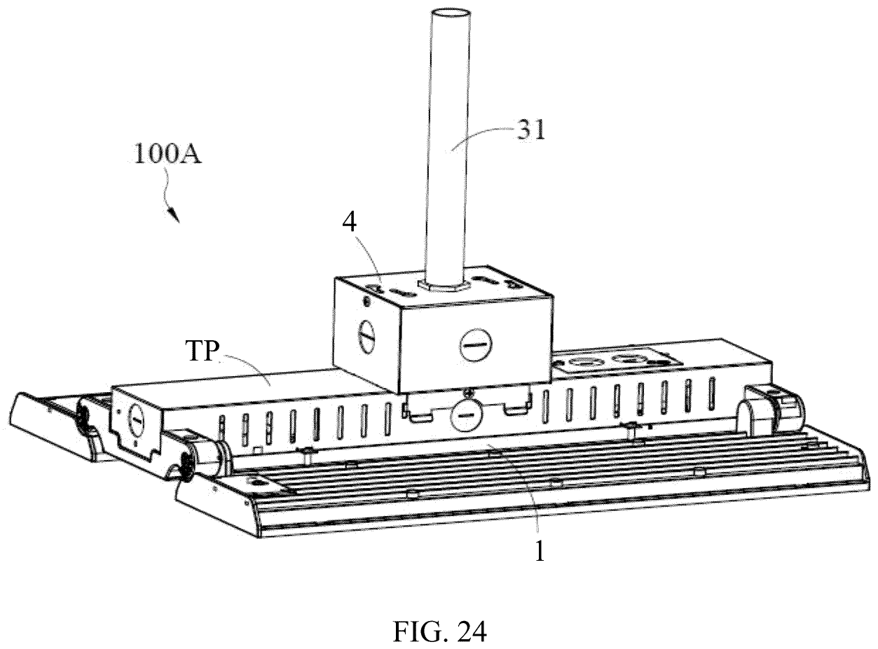

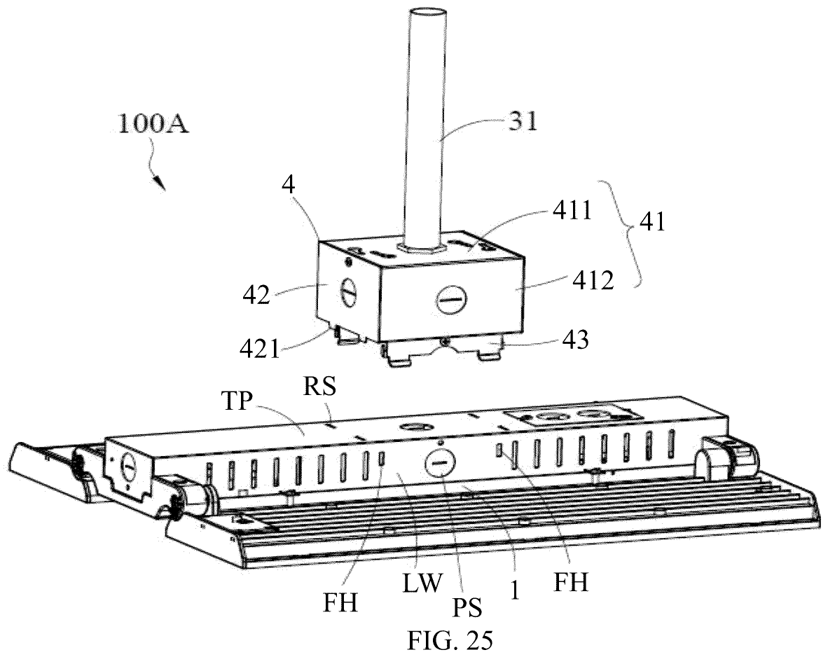

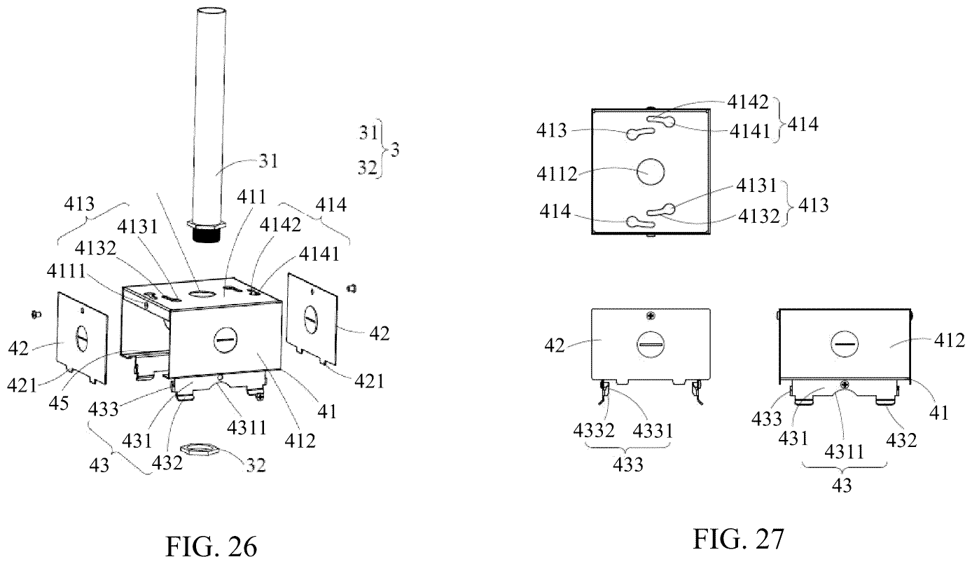

Please refer to FIG. 24 to FIG. 27. FIG. 24 is a perspective view of an industrial light fixture in accordance with a third embodiment of the disclosure. FIG. 25 is an exploded view of the industrial light fixture in accordance with the third embodiment of the disclosure. FIG. 26 is an exploded view of a ceiling box of the industrial light fixture in accordance with the third embodiment of the disclosure. FIG. 27 is a view showing the ceiling box of FIG. 24 from different view angles. The industrial light fixture 100A includes a ceiling box 4 and a base 1. The structure of the ceiling box 4 includes a main body 41 and two side covers 42. The main body 41 may be made by a metal material, and includes a supporting substrate 411 and two side plates 412 disposed on the two sides of the supporting substrate 411. The supporting substrate 411 is substantially perpendicular to the side plates 412, and the supporting substrate 411 together with the side plates 412 forms a generally U-shaped appearance. The supporting substrate 411 serves as a main installation plane for installation to a ceiling or to a rod assembly 3.

Please refer to FIG. 24 to FIG. 27. In some embodiments, the two ends of the supporting substrate 411 are provided with locking pieces 4111. The side covers 42 are fastened to the locking pieces 4111 by screws, such that the side covers 42 can be fixed to the two sides of each side plates 412. This configuration provides firm structural support, allowing the main body 41 and the side covers 42 to form a rectangular box structure.

Please refer to FIG. 24 to FIG. 27. In some embodiments, the ceiling box 4 includes a plurality of guiding structures 43 disposed on the two side plates 412. Each guiding structure 43 includes a clamping piece 431, a guiding inclined portion 432, and a hook portion 433. Each clamping piece 431 is parallel to the corresponding side plate 412. The hook portions 433 are disposed on the two sides of the corresponding clamping piece 431. The hook portions 433 disposed on the clamping piece 431 of one of the guiding structures 43 and the hook portions 433 disposed on the clamping piece 431 of another guide structure 43 extend toward each other. Each hook portion 433 includes an inwardly extending barb 4331 and a chamfered portion 4332 disposed outside the barb 4331. The chamfered portion 4332 guides the insertion of the base 1. When the hook portions 433 are engaged with fixing holes FH of the base 1, the barbs 4331 ensure firm engagement between the hook portions 433 and the fixing holes FH.

Please refer to FIG. 24 to FIG. 27. In some embodiments, each guiding inclined portion 432 of the guiding structure 43 is disposed at one side, away from the supporting substrate 411, of the corresponding clamping piece 431. In other words, the guiding inclined portions 432 are disposed at the distal end of the corresponding clamping piece 431 and extend outwardly. There are four guiding inclined portions 432 in total. Two guiding inclined portions 432 are respectively disposed on the two sides of one of the clamping pieces 431. Two guiding inclined portions 432 are respectively disposed on the two sides of another clamping piece 431. When the ceiling box 4 is installed on the base 1, the guiding structures 43 facilitate engagement and alignment of the base 1. The four guiding inclined portions 432 on the two clamping pieces 431 stably limit the four corresponding positions of the base 1.

Please refer to FIG. 24 to FIG. 27. In some embodiments, the ceiling box 4 includes bending portions 45 disposed on the two side plates 412. Each bending portion 45 is disposed on one side, away from the supporting substrate 411, of the corresponding side plate 412 opposite to the supporting substrate 411, and disposed between the side plate 412 and the guiding structure 43. Via the bending portions 45, the first distance between the clamping pieces 431 is less than the second distance between the side plates 412. When the base 1 is installed between the two clamping pieces 431, the clamping pieces 431 clamp the base 1, ensuring that the side walls LW of the base 1 are firmly engaged with the clamping pieces 431. The first distance between the clamping pieces 431 is less than or equal to the third distance between the two side walls LW of the base 1.

Please refer to FIG. 24 to FIG. 27. In some embodiments, the base 1 includes a supporting top plate TP and two side walls LW disposed on the two sides of the supporting top plate TP. The supporting top plate TP is substantially perpendicular to the side walls LW and serves as an installation plane. The supporting top plate TP is arranged parallel to the supporting substrate 411 of the ceiling box 4 and serves as the contact and supporting surface for the ceiling box 4. Each side wall LW of the base 1 is provided with two fixing holes FH, which are engaged with the two corresponding hook portions 433 of the guiding structures 43 for locking engagement.

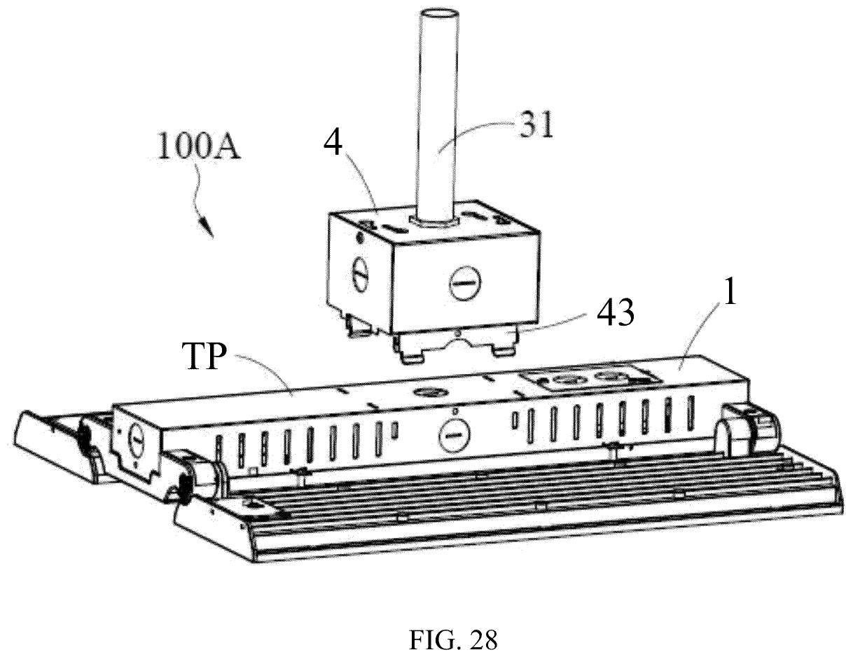

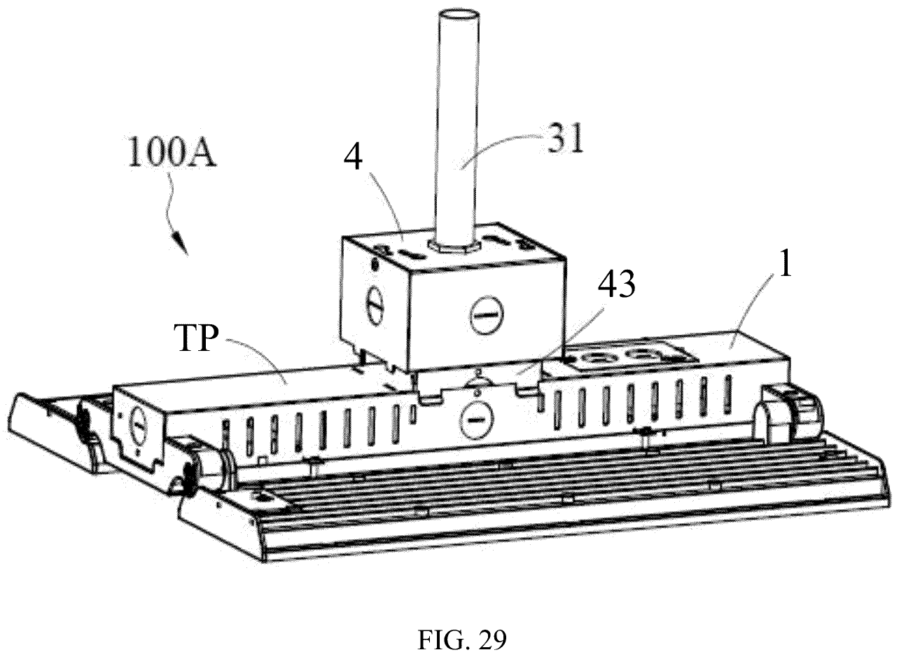

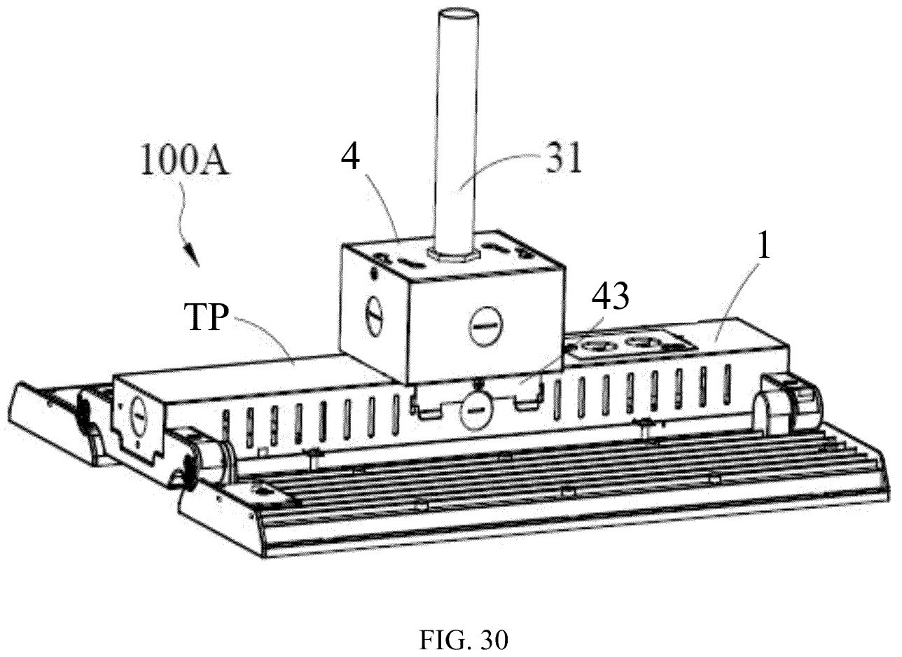

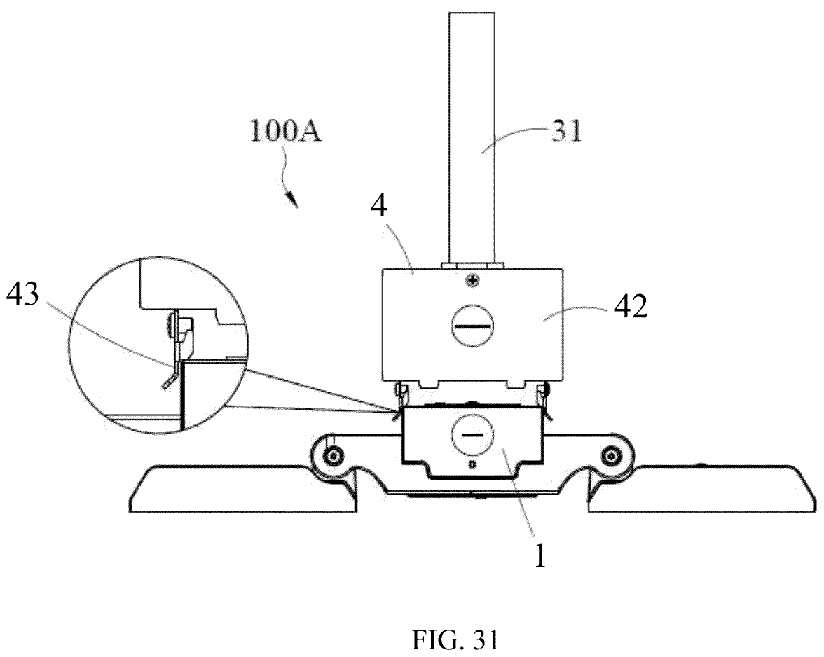

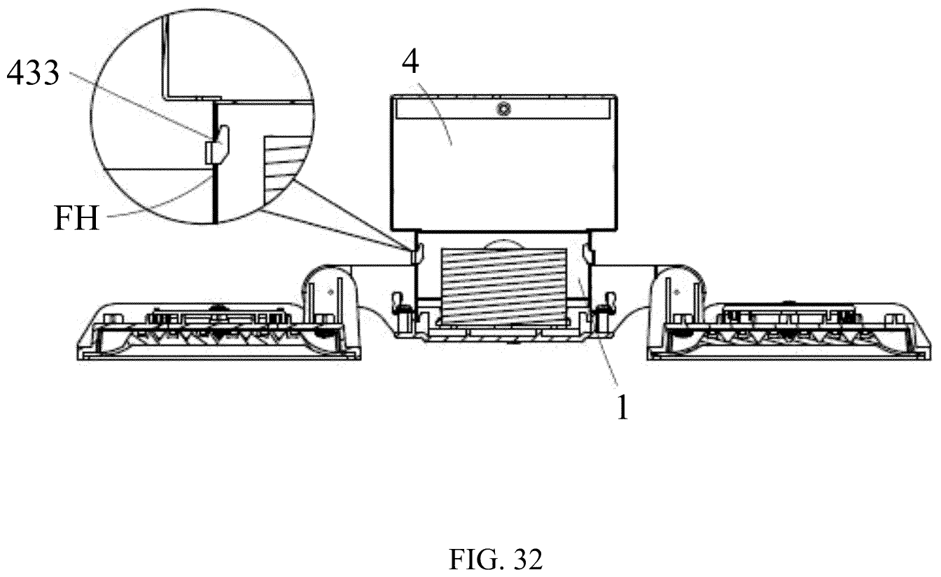

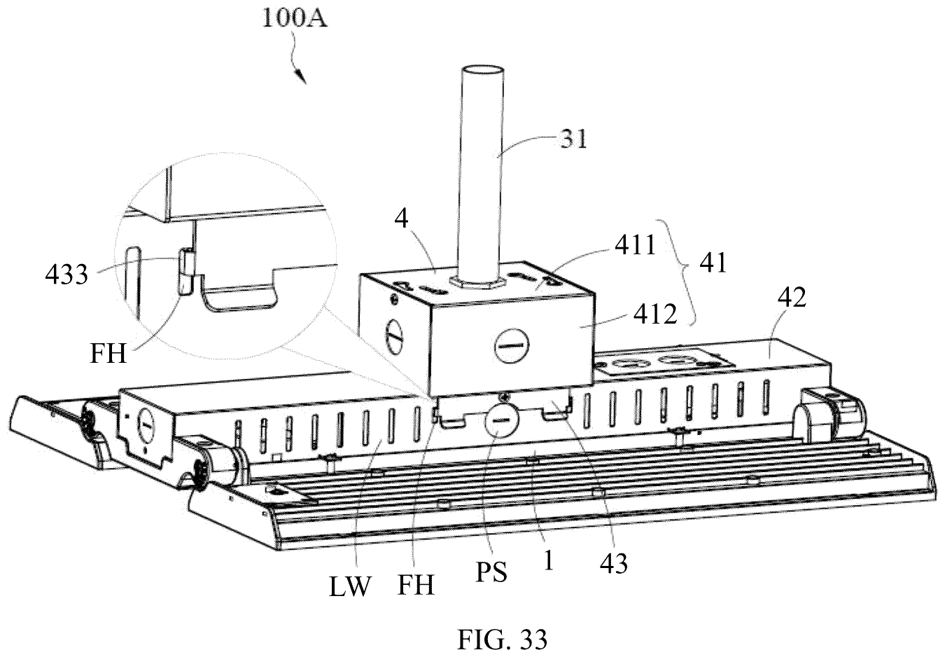

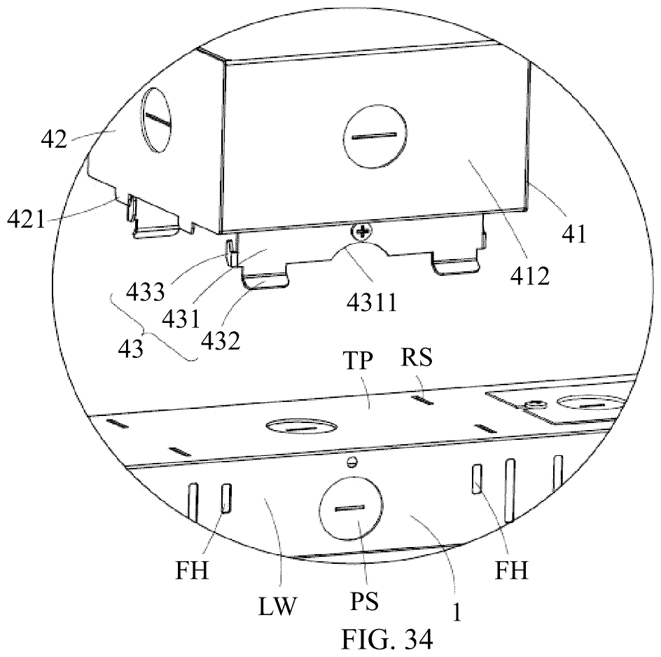

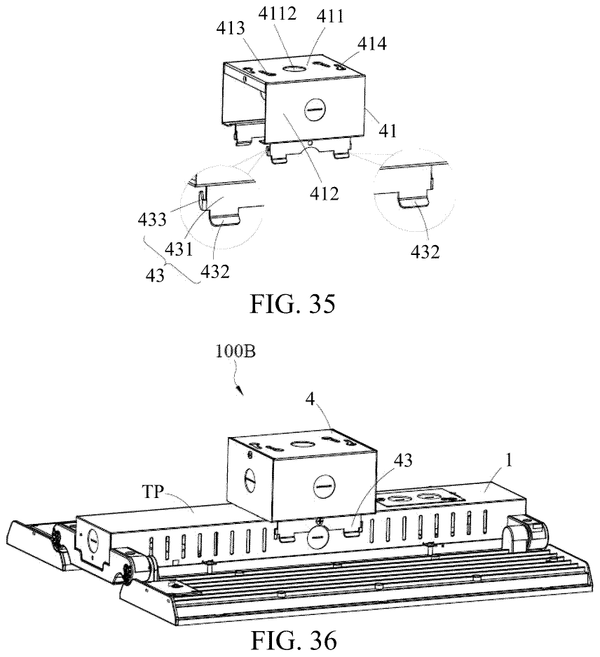

Please refer to FIG. 24 to 35. FIG. 28 is a first schematic view of the industrial light fixture in accordance with the third embodiment of the disclosure (before assembly). FIG. 29 is a second schematic view of the industrial light fixture in accordance with the third embodiment of the disclosure (during assembly). FIG. 30 is a third schematic view of the industrial light fixture in accordance with the third embodiment of the disclosure (after assembly). FIG. 31 is a first side view of the industrial light fixture in accordance with the third embodiment of the disclosure (before assembly). FIG. 32 is a second side view of the industrial light fixture in accordance with the third embodiment of the disclosure (after assembly). FIG. 33 is a first partial enlarged view of the industrial light fixture in accordance with the third embodiment of the disclosure (after assembly). FIG. 34 is a second partial enlarged view of the industrial light fixture in accordance with the third embodiment of the disclosure (before assembly). FIG. 35 is a partial enlarged view of the ceiling box of the industrial light fixture in accordance with the third embodiment of the disclosure. In some embodiments, each side cover 42 is provided with a plurality of tongue pieces 421, and the base 1 is provided with a plurality of recesses RS disposed on the supporting top plate TP. The extending directions of the recesses RS are parallel to those of the tongue pieces 421. When the side covers 42 are aligned and assembled onto the supporting top plate TP, the tongue pieces 421 of the side covers 42 engage with the recesses RS of the base 1. After engagement, lateral displacement is prevented, thereby enhancing overall stability.

Please refer to FIG. 24 to FIG. 35. In some embodiments, the side walls LW of the base 1 are provided with alignment portions PS. Each alignment portion PS is circular, although other geometrical shapes such as rectangular shapes may also be used. When the base 1 is installed between the guiding structures 43 of the ceiling box 4, each alignment portion PS corresponds to a recess portion 4311 in the guiding structure 43. During assembly, the recess portions 4311 and the alignment portions PS are aligned with each other, ensuring accurate positioning of the base 1.

Please refer to FIG. 24 to FIG. 35. In some embodiments, the industrial light fixture 100A includes a rod assembly 3. The rod assembly 3 includes a rod body 31 and a threaded portion 32. The supporting substrate 411 is provided with a locking hole 4112. The rod assembly 3 passes through the locking hole 4112 via the rod body 31, and the threaded portion 32 at the other end of the locking hole 4112 is screwed and fixed within the locking hole 4112. The threaded portion 32 and the rod body 31 are locked together to ensure firm installation of the rod assembly 3, making the structure suitable for suspended mounting scenarios.

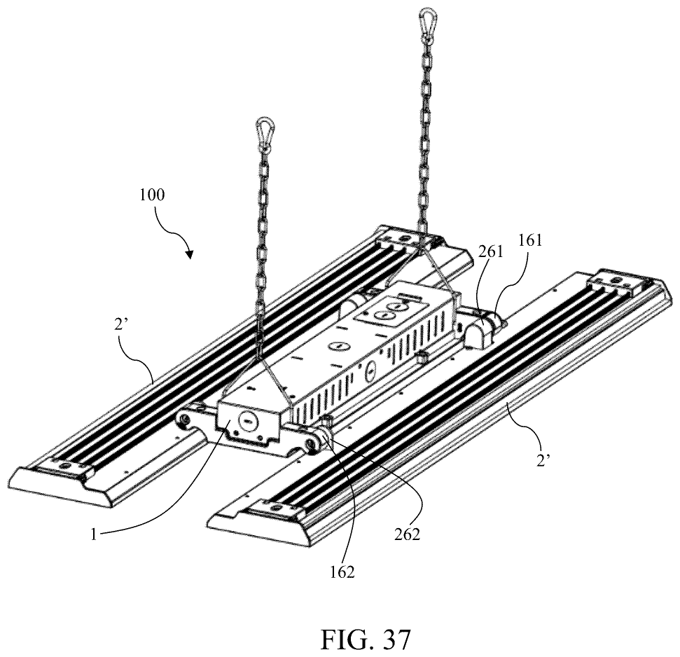

Please refer to FIG. 36. FIG. 36 is a perspective view of an industrial light fixture in accordance with a fourth embodiment of the disclosure. The embodiment illustrates the method of using an industrial light fixture 100B. First, the ceiling box 4 is fixed to the ceiling to ensure stability. Then, the base 1 is aligned with the guiding structures 43 of the ceiling box 4 and pushed in along the direction of the guiding inclined portions 432, such that the clamping pieces 431 embrace the side walls LW of the base 1. When the hook portions 433 enter the fixing holes 221 and are locked firmly, installation is completed. In some embodiments, the supporting substrate 411 of the main body 41 is provided with various installation holes to meet different application requirements. The ceiling box 4 can be mounted to a ceiling through either a first installation hole 413 or a second installation hole 414. Specifically, the first installation hole 413 includes a first installation circular hole 4131 and a first installation elongated hole 4132, which form a first hole distance suitable for screw mounting with smaller ceiling spacing. The second installation hole 414 includes a second installation circular hole 4141 and a second installation elongated hole 4142, which form a second hole distance adapted for standardized larger screw spacing on the ceiling.

To sum up, the structures of the ceiling box 4 and the base 1 satisfy the requirements of quick installation while ensuring firmness and adaptability. Furthermore, the industrial light fixtures 100A and 100B feature a novel appearance, simple structure, and compliance with market demands. The availability of multiple installation accessories enhances its versatility and applicability to various installation environments.

Please refer to FIG. 37. FIG. 37 is a perspective view of an industrial light fixture in accordance with a fifth embodiment of the disclosure. As shown in FIG. 37, the industrial light fixture 100 includes a base 1 (a power supply module is disposed inside the base 1) and a plurality of light source modules 2′. Each light source module 2′ is pivotally connected to the two sides of the base 1, such that each light source module 2′ can rotate and fold relative to the base 1 for angle adjustment. The industrial light fixture 100 of this embodiment is similar to that of the first embodiment. The difference between this embodiment and the first embodiment is that the length of the light source module 2′ is greater than the length of the base 1.

The first shaft portion 261 and the second shaft portion 262 of the light source module 2′ are disposed at a middle section of the light source module 2′, rather than at its two ends.

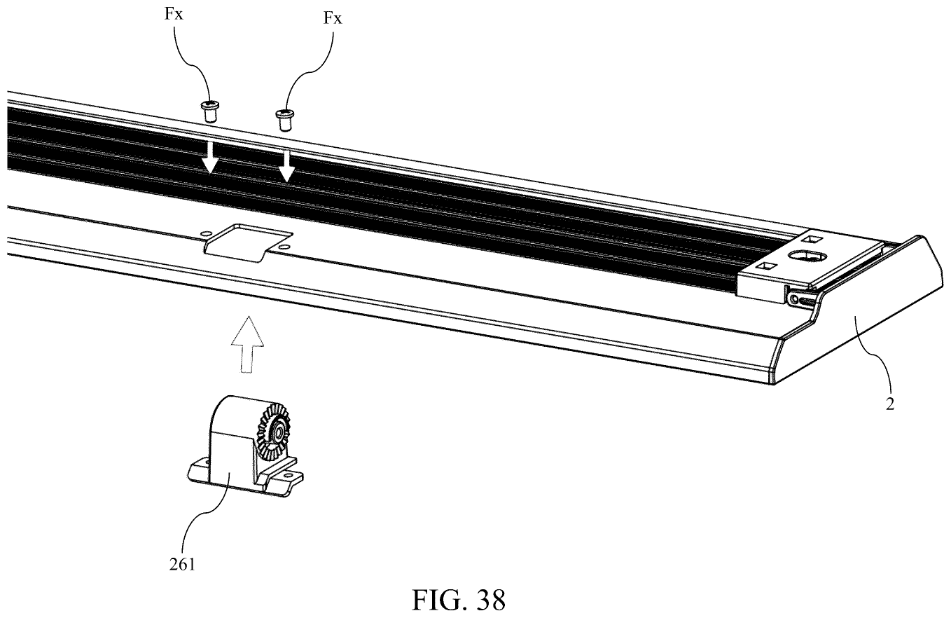

Please refer to FIG. 38. FIG. 38 is an exploded view of a light source module of an industrial light fixture in accordance with the fifth embodiment of the disclosure. As shown in FIG. 38, the first shaft portion 261 is detachably installed on the light source module 2′. The first shaft portion 261 may be secured to the light source module 2′ by two fixing members Fx (e.g., screws, bolts or other similar elements). The number of fixing members Fx may also be greater than two, depending on actual needs. Similarly, the second shaft portion 262 may be secured to the light source module 2′ in the same manner.

The industrial light fixture 100 of this embodiment, having the extended light source module 2′, can provide higher brightness and a broader illumination range to meet the requirements of various applications.

Other embodiments of the disclosure may also adopt the above structure.

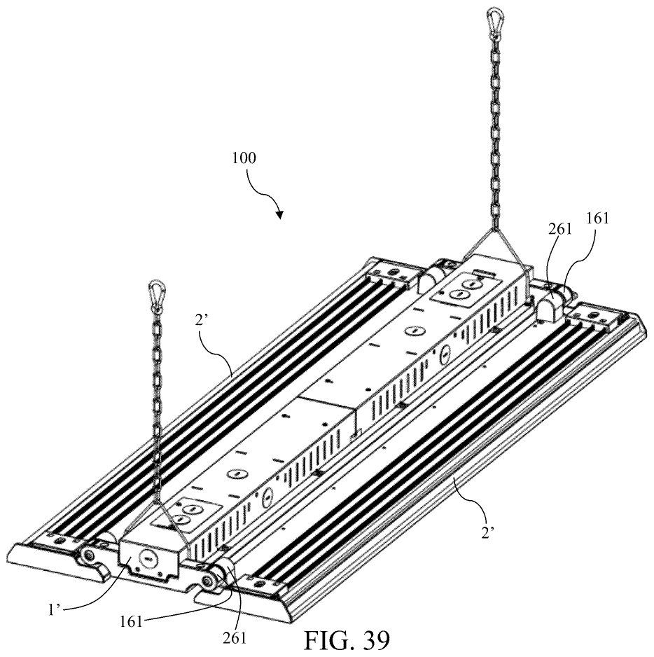

Please refer to FIG. 39. FIG. 39 is a perspective view of an industrial light fixture in accordance with a sixth embodiment of the disclosure. As shown in FIG. 39, the industrial light fixture 100 includes a base 1′ (a power supply module is disposed inside the base 1′) and a plurality of light source modules 2′. Each light source module 2′ is pivotally connected to the two sides of the base 1′, and each light source module 2′ can rotate and fold to adjust its angle relative to the base 1′. This embodiment is similar to the first embodiment. The difference between this embodiment and the first embodiment is that the length of the light source module 2′ is greater than the length of the light source module 2 of the first embodiment, and the length of the base l′ is also greater than that of the base 1′ of the first embodiment.

Additionally, the base 1′ does not include the second pivot portion 162, but instead includes four first pivot portions 161 (Two of the first pivot portions 161 are disposed on one side of the base 1′, and the other two first pivot portions 161 are disposed on the opposite side). Each light source module 2′ does not include the second shaft portion 262, but instead includes two first shaft portions 261. The two first pivot portions 161 on one side of the base 1′ are respectively connected to the two first shaft portions 261 of one light source module 2′, while the two first pivot portions 161 on the other side of the base l′ are respectively connected to the two first shaft portions 261 of the other light source module 2′. Similarly, the first shaft portion 261 is detachably installed on the light source module 2′.

The industrial light fixture 100 of this embodiment has an extended base 1′ and extended light source modules 2′, which can provide higher brightness and a broader illumination range, while also achieving high structural stability to meet various application requirements.

Other embodiments of the disclosure may also adopt the above structure.

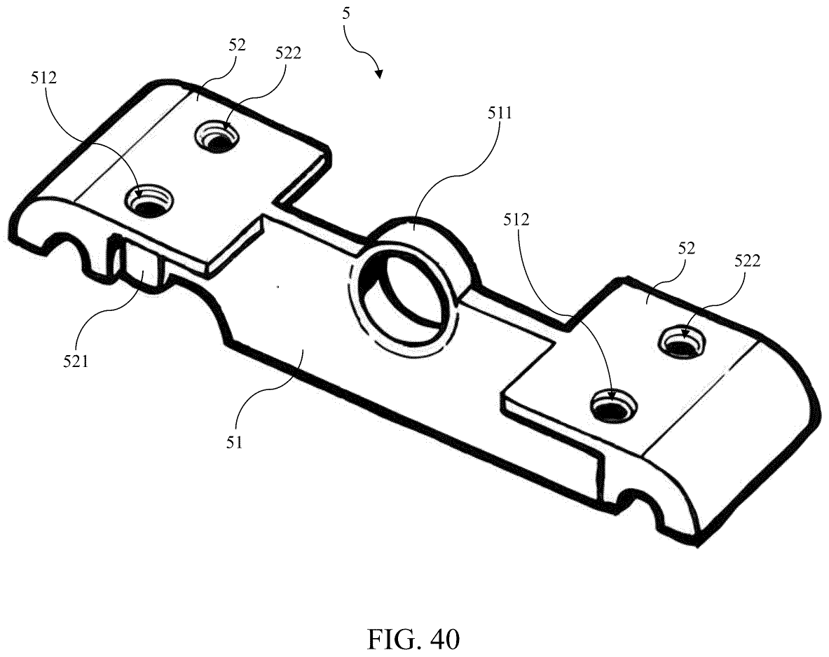

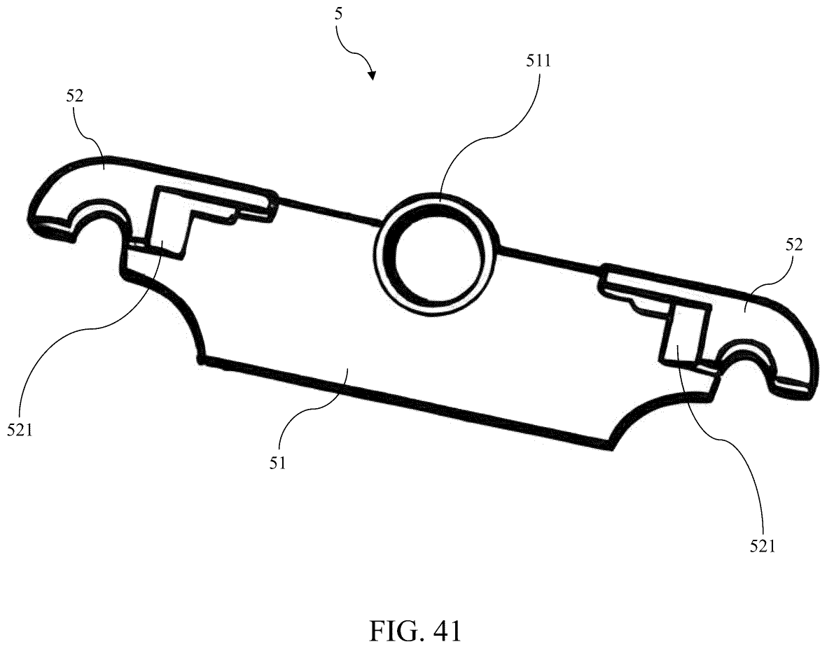

Please refer to FIG. 40 and FIG. 41. FIG. 40 is a first perspective view of a splicing member of an industrial light fixture in accordance with a seventh embodiment of the disclosure. FIG. 41 is a second perspective view of the splicing member of the industrial light fixture in accordance with the seventh embodiment of the disclosure. As shown in FIG. 40 and FIG. 41, the industrial light fixture 100 of the first embodiment may further include a splicing member 5. The splicing member 5 includes a central plate body 51 and two wing portions 52. The two wing portions 52 are respectively disposed at the two ends of the central plate body 51.

The middle portion of the central plate body 51 is provided with a hollow ring 511.

Each wing portion 52 has two hollow locking posts 521, and the two locking posts 521 are disposed below the wing portion 52. The upper surface of each wing portion 52 is provided with two screw holes 522, which respectively correspond to the two locking posts 511. Each screw hole 512 is connected to the hollow portion of the corresponding locking post 511.

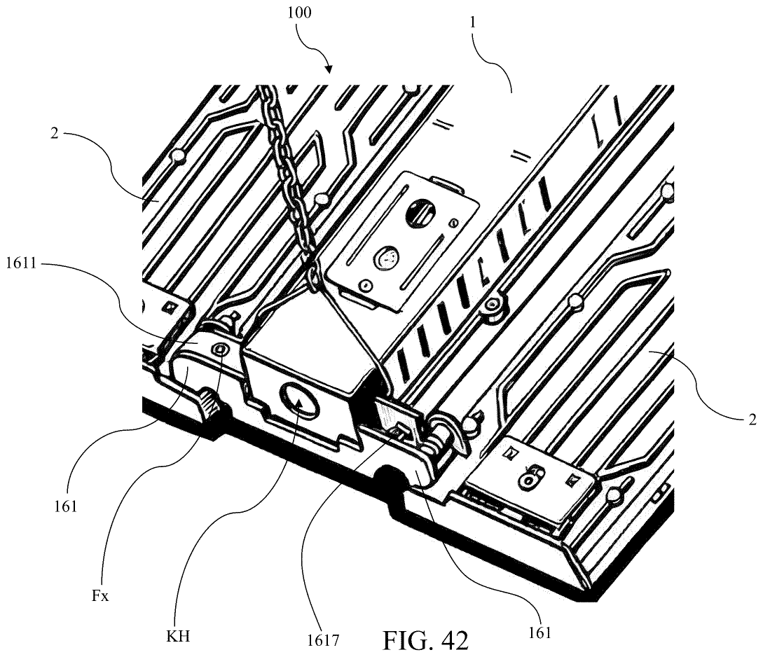

Please refer to FIG. 42, which is a first partial enlarged view of the industrial light fixture in accordance with the seventh embodiment of the disclosure. As shown in FIG. 42, each first pivot portion 161 of the base 1 further includes a decorative cover 1611 and a connecting post 1617. The connecting post 1617 is disposed in the internal space of the first pivot portion 161, and the decorative cover 1611 serves as the top surface of the first pivot portion 161. The decorative cover 1611 may be fixed to the connecting post 1617 through a fixing member Fx, such that the decorative cover 1611 is detachably connected to the connecting post 1617 and covers the internal space of the first pivot portion 161.

In addition, the two ends of the base 1 further include knock-out holes KH.

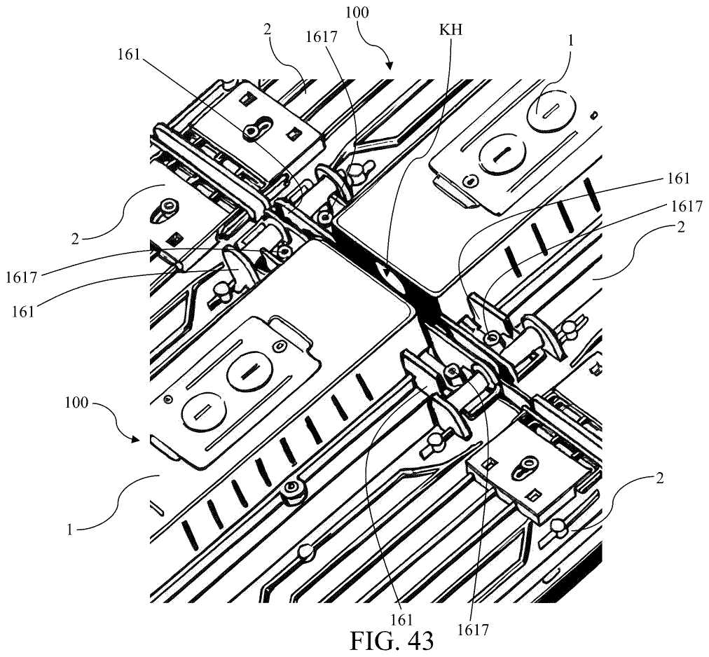

Please refer to FIG. 43, which is a second partial enlarged view of the industrial light fixture in accordance with the seventh embodiment of the disclosure. As shown in FIG. 43, when a user intends to splice two industrial light fixtures 100 together, the user may remove the decorative covers 1611 of the first pivot portions 161 of the base 1 of one industrial light fixture 100, and also remove the decorative covers 1611 of the first pivot portions 161 of the base 1 of the other industrial light fixture 100. The user may then remove the covers of the knock-out holes KH of the bases 1 of the two industrial light fixtures 100.

Next, the user may align the knock-out holes KH (the knock-out holes KH adjacent to the first pivot portions 161) of the bases 1 of the two industrial light fixtures 100 with one another.

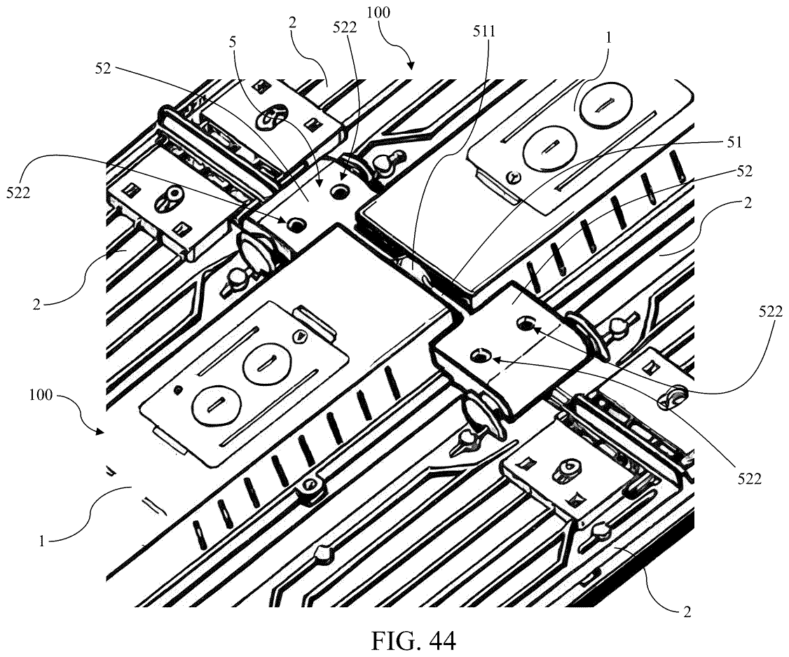

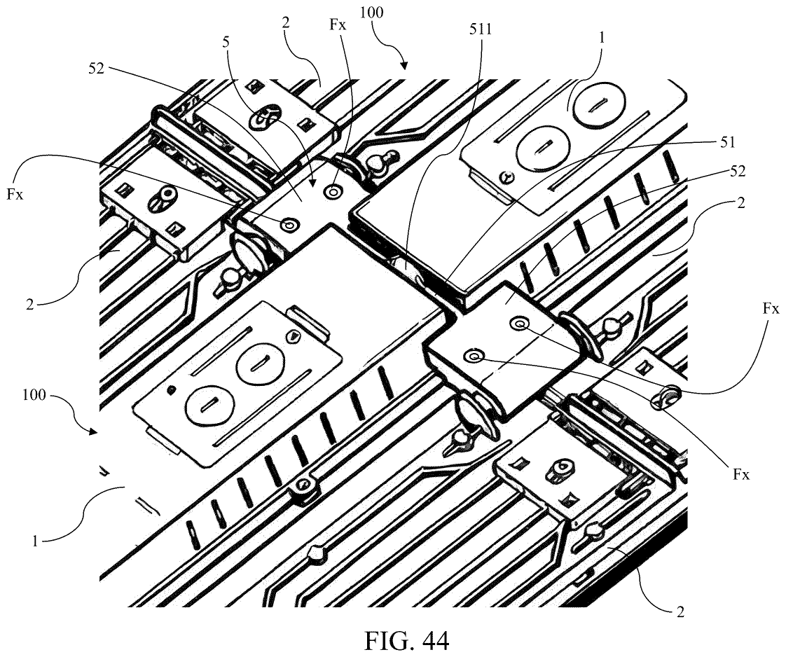

Please refer to FIG. 44A, which is a third partial enlarged view of the industrial light fixture in accordance with the seventh embodiment of the disclosure. As shown in FIG. 44A, the user may place the splicing member 5 between the two industrial light fixtures 100. In this manner, the central opening of the hollow ring 511 of the splicing member 5 can align with the knock-out holes KH of the bases 1 of the two industrial light fixtures 100, such that an electrical wire may pass through the hollow ring 511, such that the bases 1 of the two industrial light fixtures 100 can be electrically connected with each other.

In addition, the four locking posts 521 of the two wing portions 52 are also aligned with the four connecting posts 1617 of the first pivot portions 161 of the two industrial light fixtures 100.

Please refer to FIG. 44B, which is a fourth partial enlarged view of the industrial light fixture in accordance with the seventh embodiment of the disclosure. As shown in FIG. 44B, the user may insert the fixing member Fx through each screw hole 522, which also passes through the corresponding locking post 521 and the connecting post 1617. In this manner, the splicing member 5 can be fixed to the bases 1 of the two industrial light fixtures 100. Through the structural design of the splicing member 5, the base 1 of one industrial light fixture 100 can be fixed to the base 1 of another industrial light fixture 100. Thus, the user may splice two industrial light fixtures 100 together through the splicing member 5.

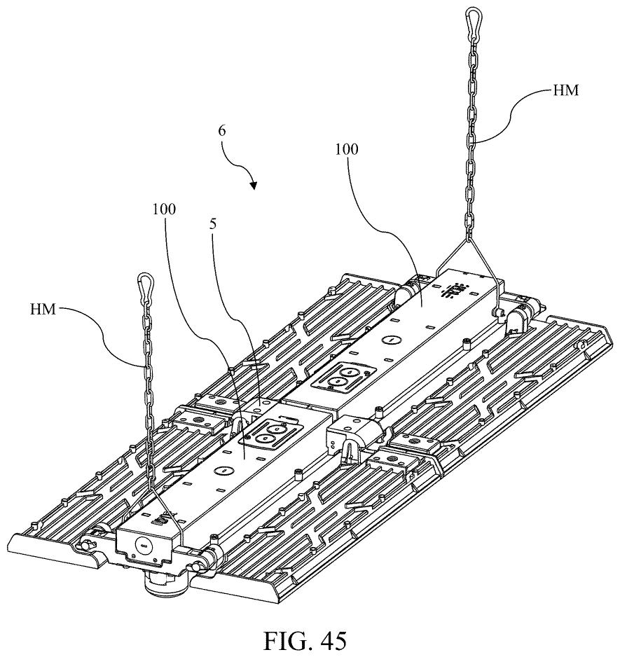

Please refer to FIG. 45, which is a perspective view of a lighting module in accordance with the seventh embodiment of the disclosure. As shown in FIG. 45, after the two industrial light fixtures 100 are spliced together, a larger lighting module 6 is formed. The lighting module 6 may further include two hanging members HM (such as chains, ropes, or other similar components), which may be respectively disposed at the two ends of the lighting module 6. Thus, the lighting module 6 may be suspended from a ceiling or other suitable locations. Three or more industrial light fixtures 100 may also be spliced together in the same manner.

This splicing structure allows multiple industrial light fixtures 100 to be spliced together to form a larger lighting module 6 to provide sufficient illumination. A user may splice two or more industrial light fixtures 100 together according to different application requirements. Therefore, this splicing structure can meet various application needs.

In addition, this splicing structure allows multiple industrial light fixtures 100 to be spliced together by using a simple splicing member 5, thereby significantly reducing usage cost.

Other embodiments of the disclosure may also adopt the above structure.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is

1. An industrial light fixture, comprising:
a base having a first pivot portion and a second pivot portion, and the base comprising a first serrated structure disposed at the first pivot portion; and
a plurality of light source modules respectively pivotally connected to two sides of the base, wherein each of the light source modules comprises an optical lens, a light source board, and a housing, wherein the optical lens and the light source board are disposed in the housing, and each of the light source modules has a first shaft portion pivotally connected to the first pivot portion and a second shaft portion pivotally connected to the second pivot portion, and the first shaft portion has a second serrated structure engaged with the first serrated structure.

2. The industrial light fixture as claimed in claim 1, wherein the first pivot portion comprises a first coupling shaft and a bolt member, and the first coupling shaft has a first circular hole, and the bolt member is configured to pass through the first circular hole to screw the first coupling shaft and the first shaft portion together.

3. The industrial light fixture as claimed in claim 1, wherein the second pivot portion comprises a second socket shaft having a second circular hole, and an outer surface of the second socket shaft is provided with an indicating scale portion.

4. The industrial light fixture as claimed in claim 3, wherein the second shaft portion comprises a protruding shaft portion and a spring sleeved on the protruding shaft portion, wherein the protruding shaft portion is pivotally connected to the second circular hole of the second socket shaft, and two ends of the spring respectively press against an inner wall of the second socket shaft and the protruding shaft portion.

5. The industrial light fixture as claimed in claim 4, wherein the scale portion comprises a plurality of scale lines, and an angle between any two of the scale lines adjacent thereto is consistent, and a range of the scale lines is from −30 degrees to 120 degrees, and the angle between any two of the scale lines adjacent thereto is 15 degrees, wherein an outer surface of the protruding shaft portion is provided with an indicating arrow corresponding to the scale lines of the scale portion.

6. The industrial light fixture as claimed in claim 5, wherein when the indicating arrows respectively point to 0 degrees, the light source modules on the two sides of the base are arranged along a horizontal line, wherein when the indicating arrows respectively point to 120 degrees, the light source modules on the two sides of the base are folded upward, whereby the optical lenses face opposite directions, wherein when the indicating arrows respectively point to −30 degrees, the light source modules on the two sides of the base are folded downward, whereby the optical lenses face each other.

7. The industrial light fixture as claimed in claim 1, wherein the first shaft portion is provided with a wire outlet hole.

8. The industrial light fixture as claimed in claim 1, wherein the first shaft portion has a protrusion portion rotatably pressing against a stopper of the first pivot portion.

9. The industrial light fixture as claimed in claim 1, wherein each of the light source modules further comprises a side cover assembly, and the housing has an internal space, a side port region, and an opening region corresponding to the internal space, wherein the light source board is disposed in the internal space, the side cover assembly is disposed in the side port region, and the optical lens covers the opening region.

10. The industrial light fixture as claimed in claim 9, wherein the housing comprises a first guide groove disposed in the side port region, and two sides of the optical lens are limited within the first guide groove.

11. The industrial light fixture as claimed in claim 9, wherein the side cover assembly comprises a first side cover plate, a second side cover plate, and a plurality of elastic members, wherein the second side cover plate is pivotally connected to the first side cover plate, and the elastic members are respectively disposed in a plurality of clamping slots of the first side cover plate, wherein two ends of each of the elastic members respectively press against the first side cover plate and a rib of the housing.

12. The industrial light fixture as claimed in claim 11, wherein the first side cover plate has a plurality of tongue pieces, and each of the elastic members is limited between two of the tongue pieces.

13. The industrial light fixture as claimed in claim 11, wherein the side cover assembly comprises a screw member, and the first side cover plate has an elongated hole, wherein the screw member is configured to pass through the elongated hole to screw the first side cover plate and the housing together.

14. The industrial light fixture as claimed in claim 1, further comprising a ceiling box, and the ceiling box comprises a main body and two side covers, wherein the main body has a supporting substrate and two side plates disposed at two sides of the supporting substrate, and the two side covers are respectively disposed at two sides of each of the two side plates.

15. The industrial light fixture as claimed in claim 14, wherein the ceiling box further comprises a plurality of guiding structures disposed on the two side plates, and each of the guiding structures has a clamping piece, a plurality of guiding inclined portions, and a plurality of hook portions, wherein each of the guiding inclined portions is disposed on one side, away from the supporting substrate, of the clamping piece corresponding thereto, wherein the guiding inclined portions extends outward in opposite directions, and the hook portions are respectively disposed on two sides of the clamping piece corresponding thereto.

16. The industrial light fixture as claimed in claim 15, wherein the hook portions disposed on the clamping piece of one of the guiding structures and the hook portions disposed on the clamping piece of another of the guide structures extend toward each other.

17. The industrial light fixture as claimed in claim 16, wherein the base has a top supporting plate and two side walls disposed at two sides of the top supporting plate, wherein each of the side walls has a plurality of fixing holes, and the hook portions are respectively engaged with the fixing holes.

18. The industrial light fixture as claimed in claim 17, wherein the main body has a plurality of first installation holes and a plurality of second installation holes disposed at the supporting substrate, wherein each of the first installation holes has a first installation circular hole and a first installation elongated hole connected to each other, each of the second installation holes has a second installation circular hole and second installation elongated hole connected to each other, wherein a first hole distance defined by the first installation holes is less than a second hole distance defined by the second installation holes.

19. The industrial light fixture as claimed in claim 1, wherein the first pivot portion comprises a decorative cover and a connecting post, and the connecting post is disposed in an internal space of the first pivot portion, wherein the decorative cover serves as a top surface of the first pivot portion, and detachably connected to the connecting post.

20. The industrial light fixture as claimed in claim 19, wherein the industrial light fixture further comprises a splicing member configured to fix the base to a base of another industrial light fixture.
